(19) United States
(12) Patent Application Publication
(10) Pub. No.: US 2012/0138758 A1
(43) Pub. Date: Jun. 7, 2012

(54) FENCING BRACKET SYSTEM

(75) Inventor: Loren R. Graber, Nappanee, IN (US)

(73) Assignee: DIGGER SPECIALTIES, INC., BREMEN, IN (US)

(21) Appl. No.: 13/307,752

(22) Filed: Nov. 30, 2011

Related U.S. Application Data
(60) Provisional application No. 61/418,024, filed on Nov. 30, 2010.

(51) Int. Cl. F16M 13/02

(52) U.S. Cl. 248/221.11

(57) ABSTRACT

A fence bracket that attaches to a fence post and rail wherein the rail includes a raised notch on its surface is provided. The fence bracket includes at least one panel and a flange portion. The at least one panel is configured to wrap around at least a portion of the fence post. The flange portion is configured to extend from the fence post when the panel is attached thereto. The flange further includes a recess disposed thereon and configured to receive the raised notch. Still further, the flange includes a bore configured to receive a fastener that is attachable to the rail.

### RELATED APPLICATIONS

The present application is related to and claims priority to U.S. Provisional Patent Application, Ser. No. 61/418,024, filed on Nov. 30, 2010, entitled “Fencing Bracket.” The subject matter disclosed in that provisional application is hereby expressly incorporated into the present application.

### TECHNICAL FIELD AND SUMMARY

The present disclosure is related to metal fencing products, and particularly to bracket systems that attach fence rails to fence posts and other structures.

Conventional metal picket-type fences include horizontal rails that extend between vertically oriented posts that are fixed in the ground. Attached to the horizontally extending rails are vertically oriented pickets periodically spaced along the rails inbetween each post. Successive sections of these posts, rails, and pickets form a fence line.

The present disclosure is directed to bracket systems that attach the horizontal rails to the vertical fence posts. Prior art fence posts, such as aluminum or steel posts, include routed holes. These holes are each adapted to receive a horizontal rail. Typically the rail has a notch extending from each sidewall. This makes that portion of the rail slightly larger than the routed opening of the post. The rail can be pushed into the opening of the post. Enough give in the rail (and notch) allows this to happen. Once the end of the rail is secured into the post, however, the notch expands enough to prevent the rail from backing out of the post. Alternatively, some rails include holes that receive fasteners that engage both the rail and the post attaching the two together.

An issue with all of this is different rails, brackets, and post designs limit modularity. The bracket systems described herein can be used on either routed posts (i.e.,with rail holes) or blank posts (i.e., no rail holes). This means the fence can be made regardless of which type of posts are presently in stock.

The bracket systems of the present disclosure are configured to handle any of the three fence configurations-in-line, corner, or in-wall/end. The in-line configuration means the bracket is configured to carry a rail on each side of the post coaxially aligned with each other. In other words, a line bracket holds tandemly aligned rails to the posts. This forms a fence line. The corner bracket is configured to hold two rails, each of which are positioned at an angle with respect to each other. As the title implies, these brackets attach to corner posts and hold a first rail positioned in one orientation and a second rail in another orientation (e.g., 90°) with respect to that first rail. The end bracket is configured to attach the rail to some other structure, such as a wall or ending post. One portion of the bracket attaches to the wall, while another portion attaches to the rail.

An embodiment of the line bracket includes linearly opposed recesses and fastener holes to linearly hold aligned rails. Another fastener hole in the bracket attaches the bracket to the post. In an illustrative embodiment, two brackets, one located on each side of a post, are each employed to hold one side of each rail. It is further appreciated that a portion of each line bracket that secures to the fence post is illustratively “U”-shaped to partially wrap around that portion of the fence post. This positions the periphery of each line bracket to properly engage the rails. The notch from each rail engages the corresponding recess from the line bracket. A fastener may also extend through both the line bracket and the rail via the fastener's bores in the rail securing the rail to the bracket.

An illustrative embodiment of the corner bracket assembly includes “C”-shaped brackets that also partially wrap around the fence post. A first bracket, or bracket portion, includes a pair of flanges that extend from the opening of the corner bracket or bracket portion. Each flange includes a recess and fastener hole, similar to the line bracket. It is, thus, contemplated that one bracket or bracket portion can attach to both sides of the rail. The corner bracket assembly also includes a second bracket or bracket portion that includes extending flanges that attach to a second rail, in similar fashion to the aforementioned first bracket or bracket portion. In this illustrative embodiment, however, these flanges are illustratively oriented perpendicular or some other angle with respect to the flanges of the first bracket or bracket portion. The first and second brackets or bracket portions are illustratively engageable with each other and their flanges are configured to hold their respective rails at the same height or elevation.

Another illustrative embodiment of the present disclosure includes a fence bracket that attaches to a fence post and rail wherein the rail includes a raised notch on its surface. The fence bracket comprises at least one panel and a flange portion. At least one panel is configured to wrap around at least a portion of the fence post. The flange portion is configured to extend from the fence post when the panel is attached thereto. The flange further includes a recess disposed thereon and configured to receive the raised notch. Still further, the flange includes a bore configured to receive a fastener that is attachable to the rail.

In the above and other embodiments, the fence bracket may further comprise: a second flange wherein the at least one panel being configured to wrap around the post such that the flange and second flange face each other forming a space there between and configured to receive the rail in that space, and wherein the second flange includes a recess and a bore; the panel being U-shaped with the flange and the second flange located at the distal ends of the U-shape; the panel being C-shaped with the flange and the second flange located at the distal ends of the C-shape, and extending perpendicular to a space formed by the distal ends of the C-shape, and wherein the flange and second flange being spaced apart from and face each other; the panel including a second flange that extends from the panel at an end distal from the flange; the bracket further configured to include a second panel identical to the panel and configured to attach to the fence post opposite the panel and attach to the rail; the panel and second panel being configured to attach to the fence post opposite each other to form a space between opposed flange and second flange which are configured to hold the rail and a second rail linearly to each other; the panel being configured to attach to a wall; the C-shaped panel including a linearly-extending edge along the length of the panel, and wherein the flange and second flange are sized to extend above the linearly-extending edge of the panel; the flange and second flange having a height that is double the height of the panel; the C-shaped panel being configured to stack onto a second bracket with a second C-shaped panel such that the flange and second flange of the C-shaped panel being located about perpendicular to the flange and second flange of the second C-shaped panel; and the panel including at least one fastener bore disposed therethrough.

Additional features and advantages of the fencing bracket system will become apparent to those skilled in the art upon consideration of the following detailed descriptions exemplifying the best mode of carrying out the fencing bracket system as presently perceived.

### BRIEF DESCRIPTION OF DRAWINGS

The present disclosure will be described hereafter with reference to the attached drawings which are given as non-limiting examples:

FIG. 1 is a perspective view of a fencing system;

FIG. 2 is a partially exploded view of a fencing system;

FIG. 3 shows several views of brackets, fasteners, and a post;

FIGS. 4a and b are facing and top views of a line bracket;

FIGS. 5a-c are top, side, and perspective views of a corner bracket system;

FIGS. 6a-c are top, side, and rear views of an end bracket system; and

FIGS. 7a and b are side and top views of a post with a line bracket, corner bracket, and end bracket.

Corresponding reference characters indicate corresponding parts throughout the several views. The exemplification set out herein illustrates embodiments of the disclosure, and such exemplification is not to be construed as limiting the scope of the disclosure in any manner.

### DETAILED DESCRIPTION OF THE DRAWINGS

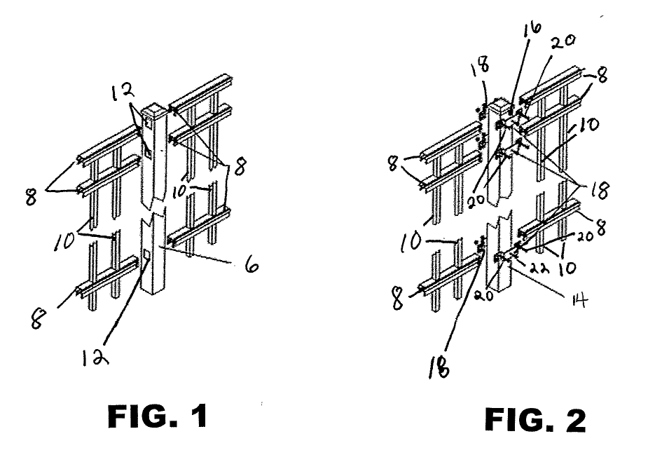

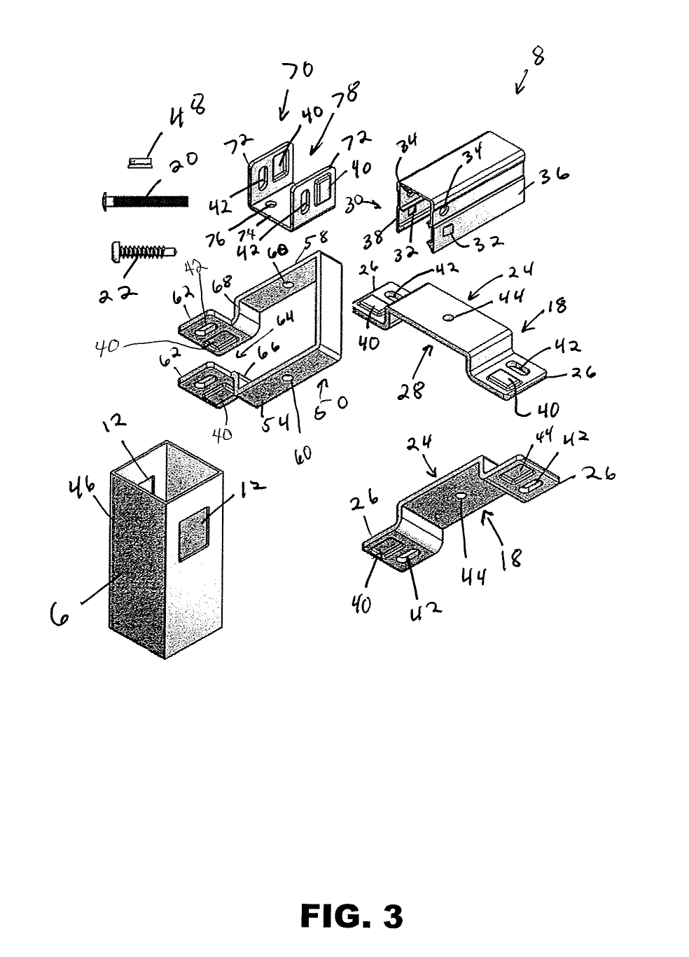

A perspective, partially exploded views of a fencing system 2 and 4 are shown in FIGS. 1 and 2, respectively. System 2 of FIG. 1 includes post 6, rails 8, and pickets 10. In this illustrative embodiment, routed openings 12 are located along the sides of post 6, each configured to receive an end of rail 8. A notch 32 (see, also, FIG. 3) is illustratively located on the side at about each end of rail 8 to secure the same to post 6. Fencing system 4 shown in FIG. 2 includes a post 14, rails 8, and pickets 10. This embodiment differs from system 2 in that post 14 does not include openings 12 that receive rails 8. Instead, a bracket system 16 couples rails 8 to post 14. Included with bracket system 16 are line brackets 18 that attach rails 8 to post 14 via fasteners 20 and 22, respectively. In the illustrative embodiment, line bracket 18 is positioned on each side of post 14, as well as rail 8, to secure both sides of rail 8 to post 14 as shown. Line bracket 18, as discussed further herein, is configured to attach rails 8 to post 14 in a linear manner. In other words, using brackets 18 creates a straight fence line of rails 8. It is also appreciated that despite openings 12 in post 6, as shown in FIG. 1, bracket system 16 can be used with posts 6 as well. The only difference is that openings 12 are not used. This allows the fence builder to use whichever posts 6 or 14 that are available.

Fence sections that have rails 8 inserted into openings 12 of post 6 are not usually mixed with sections that employ bracket system 16 to connect rails 8 to post 14. The reason for this is that besides esthetic continuity, the span between fence posts is different. For example, the distance between the center of two fence posts 6 using a standard eight foot rail inserted into post 6 is 94 inches. Conversely, the same eight foot rail produces a 96 inch on center span between posts 14 because none of the rails are inserted into posts 14.

Several views of brackets, fasteners and a post are shown in FIG. 3. These views show post 6 with opposed openings 12 disposed therein. Illustratively, post 6 has a square-cross-section. It is appreciated, however, that other cross sections, such as round or rectangular, can be employed. Various perspective views of line bracket 18 of bracket system 16 are also shown. In this illustrative embodiment, each bracket 18 comprises an illustrative “U”-shaped bracket section 24 with flanges 26 extending therefrom. The “U”-shaped section 24 profile is illustrative because it is intended to fit a portion of the perimeter of square post 6. In other words, a cross-section of post 6 is configured to fit in a formed cavity 28 in bracket section 24. Flanges 26 extend from post 6 (or 14 for that matter) to receive rail 8. The end portion 30 of rail 8 shown in this view includes a notch 32 and a fastener bore 34 on each side 36 and 38 of rail 8. As discussed with respect to FIG. 1, the cross section of rail 8 is configured to fit into the shape of opening 12 to receive end 30 of rail 8. Notches 32 may be illustratively formed from the side material of rail 8. In an illustrative embodiment, the material can be extruded aluminum with the notch 32 punched out. A recess 40 and illustrative hole or slot 42 is configured to accommodate notch 32 and fastener bore 34, respectively. Fastener 20 is disposable through both slot 42 and bore 34 in both sides of rail 8 to secure rail 8 to bracket 18. Notch 32 illustratively fits into the recess 40, so flanges 26 abut up against sides 36 or 38 of rail 8. Nut 48 screws onto fastener 20 that extends through both fastener bores 34 and rail 8 securing rail 8 to two opposing line brackets 18. Fastener hole 44 is configured to receive fastener 22 that extends into wall 46 of post 6.

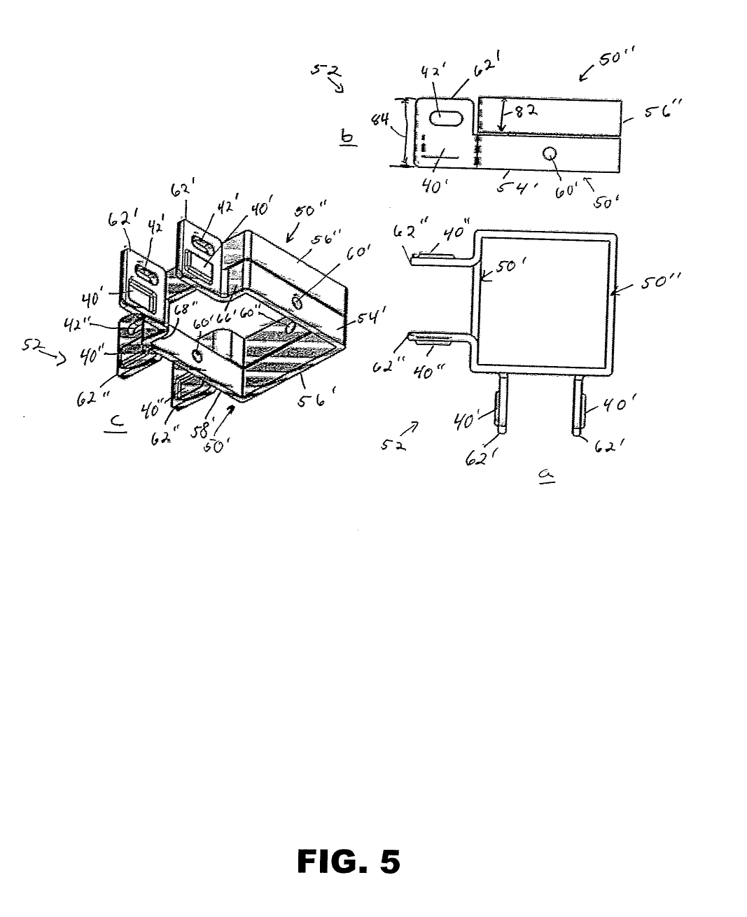

A corner bracket 50 which is part of a corner bracket system 52 (see, also, FIG. 5) is configured to couple rail 8 on one side of post 6. It is contemplated that a plurality of brackets 50 oriented perpendicular to each other (see, also, FIG. 5) serve to attach rails to posts 6 or 14 perpendicular or at some other angle with respect to each other. Bracket 50 has an illustrative “C”-shaped profile. Illustratively, bracket 50 includes three sides 54, 56 and 58 that wrap around three sides of either posts 6 or 14 and secure thereto via fastener 22 extending through fastener holes 60. Flanges 62, similar to flanges 26, extend outward from bracket 50 forming a space 64 therebetween sized to receive rail 8. Recesses 40 and slots 42 are located on flanges 62, similar to that of flanges 26. Side segments 66 and 68 help determine the width of space 64 ensuring proper receipt of rail 8.

A “U”-shaped wall bracket 70 shown in FIG. 3 is configured to attach one end of rail 8 to a structure such as a wall. The “U”-shape of bracket 70 differs from the shape of line bracket 18 in that the walls of bracket 70 form flanges 72 similar to flanges 18 and 62, not a bracket section like bracket section 24. Flange 72 includes slot 42 and recess 40 similar to flanges 62 and 26. Also similar to those embodiments, notch 32 from rail 8 is configured to fit in recess 40 and bores 34 are configured to line up with slot 42 in order to receive fastener 20 and nut 48 to secure rail 8 to bracket 70. It is appreciated that space 78 is sized to receive rail 8. End plate 74 includes bore 76 so a fastener can attach bracket 70 to a surface or structure.

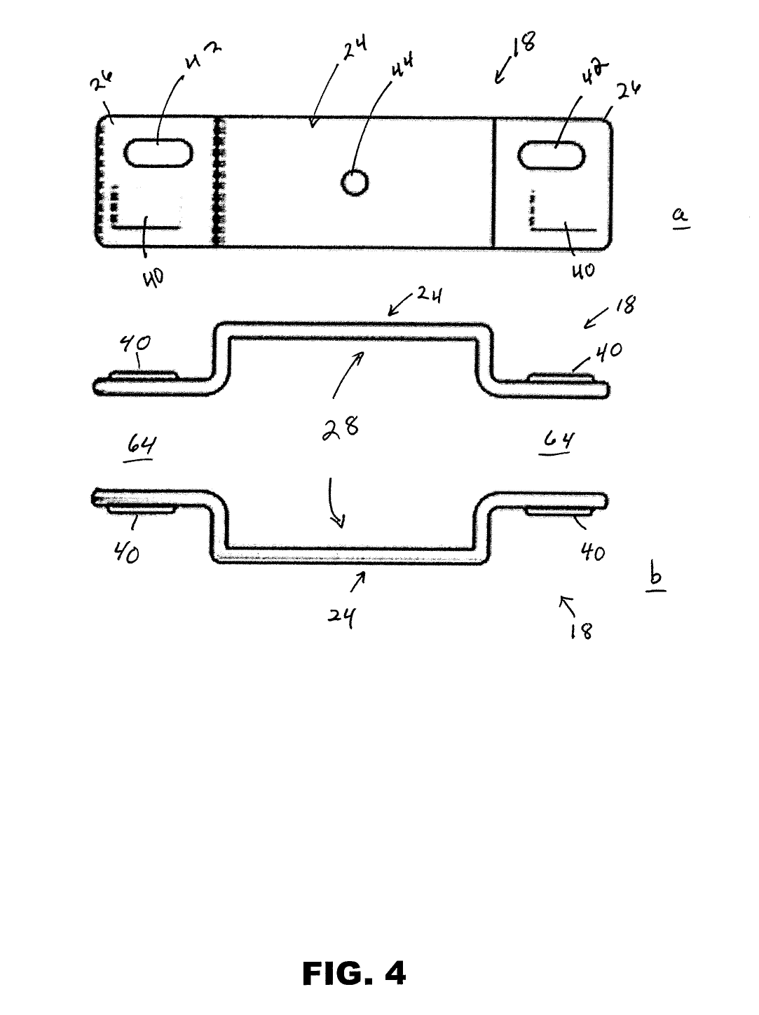

Facing and top views of line bracket 18 are shown in FIGS. 4a and b. The view shown in FIG. 4a includes slots 42 and recess 40. Fastener hole 44 is also shown. Two line brackets 18 are shown in FIG. 4b depicting their positioning on a post (not shown in this figure) from the top view. Bracket sections 24 are configured to partially wrap around the post which fits into cavities 28. As a result, space 64 is formed to receive rail 8. This view also shows how recess 40 receives notch 32 from each side of rail 8. (See also FIG. 3.)

Top, side, and perspective views of corner bracket systems 52 are shown in FIGS. 5a-c. The top view of FIG. 5a particularly illustrates how brackets 50 can be oriented perpendicular to each other to facilitate mounting rails 8 on a corner post. In this instance, flanges 62′ of first corner bracket 50′ is illustratively oriented in a first direction and flanges 62″ of the second bracket 50″ are oriented perpendicular to the first bracket 50′. It is appreciated that bracket 50″ can be oriented either perpendicular to the left, right, or in a straight line with respect to flanges 62′ of bracket 50′. One issue, however, is how to accommodate the flange sizes needed to hold rails 8 so they maintain the same height between fence sections. FIG. 5b demonstrates how side 56″ (along with sides 54″, 58″, and sides 54′, 56′ and 58′, for that matter) has a first illustrative height 82 which is less than height 84 of flange 62. As this view shows, positioning 50″ onto 50′ in any orientation still allows separate rails 8 to be attached to system 52 while maintaining the same height. A difference between bracket 50′ and 50″ is shown in the perspective view of FIG. 5c. Bracket 50′ includes flanges 62′ that extend upward so that slot 42′ is located at an upper position and recess 40′ is located at a lower position making both flange sets consistent configurations with bore 34 and notch 32, respectively, of rail 8. This view also shows recess 40′ to accommodate notch 32 of rail 8. In contrast, FIG. 50″ includes flanges 62″ that extends downward overlapping sides 54′, 56′, or 58′ with slot 42″ and recess 40″ positioned in reverse orientation to that of flange 62′. The reason for this is bracket 50″ is flipped so that flanges 62′ and 62″ are the same height to properly accommodate rail 8. In so doing, the orientation of slot 42″ and recess 40″ must likewise be flipped or reoriented on flange 62″.

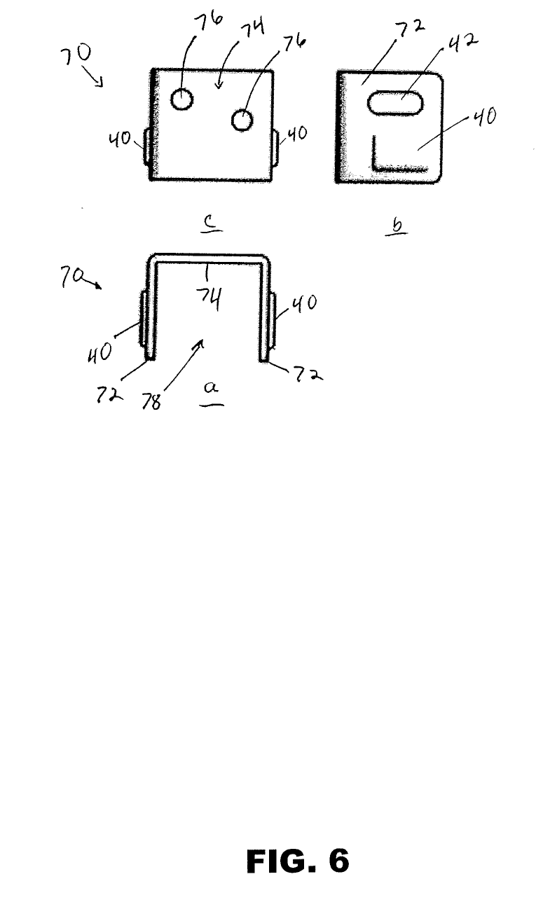

Top, side, and rear views of end bracket 70 are shown in FIGS. 6a-c. Similar to prior embodiments, flanges 72 include recesses 40 and slots 42 similar to brackets 50 and 18. Also similar to other embodiments is space 78 as shown in FIG. 6a to receive rail 8. End plate 74, as shown in FIG. 6c, includes bores 76 to fasten bracket 70 to a wall or other structure.

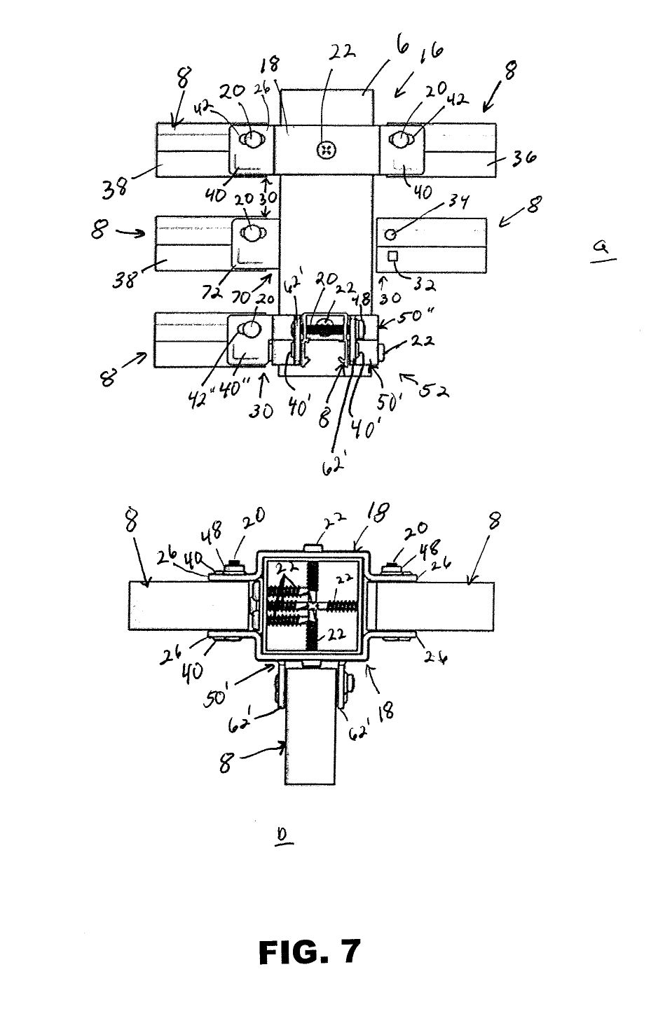

FIGS. 7a and b are side and top views of post 6 with line bracket system 16, corner bracket system 52, and end bracket 70 attached thereto depicting how they attach to a fence post. Line bracket 18 is shown attached to post 6 via fastener 22 disposed through both. Fence rails 8 are fastened to flanges 26 via fasteners 20 extending through slot 42 and into rails 8. FIG. 7b also shows that fasteners 20 extend through rails 8 and attach to an opposed line bracket 18 and secured thereto via nut 48. Both FIGS. 7a and b demonstrate how using the brackets in the configuration shown secure rails 8 to post 6 in a linear fashion needed for such fence rail attachments. Bracket 70 is shown attached to post 6 in FIG. 7a with a rail 8 attached to bracket 70 via fastener 20 in the same manner as that described with respect to flanges 26 of bracket 18. Lastly, the perpendicular arrangement of corner bracket system 52 demonstrates how brackets 50′ and 50″ are oriented so that rails 8 can be positioned perpendicular to each other as required for a corner fencing section.

Corresponding reference characters indicate corresponding parts throughout the several views. The exemplification set out herein illustrates an embodiment of the invention, in one form, and such exemplification is not to be construed as limiting the scope of the invention in any manner.

What is claimed is:

1. A fence bracket that attaches to a fence post and rail wherein the rail includes a raised notch on its surface, the fence bracket comprising:
at least one panel configured to wrap around at least a portion of the fence post; and
a flange portion configured to extend from the fence post when the panel is attached thereto;
wherein the flange further includes a recess disposed thereon and configured to receive the raised notch; and
wherein the flange further includes a bore configured to receive a fastener that is attachable to the rail.

2. The fence bracket of claim 1, further comprising a second flange wherein the at least one panel is configured to wrap around the post such that the flange and second flange face each other forming a space there between and configured to receive the rail in that space, and wherein the second flange includes a recess and a bore.

3. The fence bracket of claim 2, wherein the panel is U-shaped with the flange and the second flange located at the distal ends of the U-shape.

4. The fence bracket of claim 2, wherein the panel is C-shaped with the flange and the second flange located at the distal ends of the C-shape, and extending perpendicular to a space formed by the distal ends of the C-shape, and wherein the flange and second flange are spaced apart from and face each other.

5. The fence bracket of claim 1, wherein the panel includes a second flange that extends from the panel at an end distal from the flange.

6. The fence bracket of claim 5, further configured to include a second panel identical to the panel and configured to attach to the fence post opposite the panel and attach to the rail.

7. The fence bracket of claim 6, wherein the panel and second panel are configured to attach to the fence post opposite each other to form a space between opposed flange and second flange which are configured to hold the rail and a second rail linearly to each other.

8. The fence bracket of claim 3, wherein the panel is configured to attach to a wall.

9. The fence bracket of claim 4, wherein the C-shaped panel includes a linearly-extending edge along the length of the panel, and wherein the flange and second flange are sized to extend above the linearly-extending edge of the panel.

10. The fence bracket of claim 4, wherein the flange and second flange have a height that is double the height of the panel.

11. The fence bracket of claim 9, wherein the C-shaped panel is configured to stack onto a second bracket with a second C-shaped panel such that the flange and second flange of the C-shaped panel is located about perpendicular to the flange and second flange of the second C-shaped panel.

12. The fence bracket of claim 1, wherein the panel includes at least one fastener bore disposed therethrough.
